(19) United States
(12) Patent Application Publication
(10) Pub. No.: US 2014/0345184 A1
(43) Pub. Date: Nov. 27, 2014

(54) SPRING CLASP GUIDE

(71) Applicant: Richard Holcomb, Tucson, AZ (US)

(72) Inventor: Richard Holcomb, Tucson, AZ (US)

(21) Appl. No.: 13/900,752

(22) Filed: May 23, 2013

(51) Int. Cl. A01K 87/04

(52) U.S. Cl. CPC A01K 87/04
USPC 43/24

(57) ABSTRACT

A spring clasp guide for providing an easier method of feeding a fishing line through a fishing guide comprising a substantially circular body and a spring clasp mechanism which, when actuated reveals a closeable gap in the circumference body portion of the guide. By revealing a gap in the body of the guide through which fishing line can be received, the spring clasp mechanism eliminates the need for a fisherman to feed line through the eyes of a plurality of guides sequentially and spend excessive time on preparing a fishing pole. On the contrary, a fisherman utilizing spring clasp guides on a fishing rod can simply actuate the spring clasp mechanism, insert the line through the closeable gap that is created, and release the spring clasp mechanism to cause the closeable gap to vanish and restore the integrity of the circumference body portion of the guide.

### BACKGROUND OF THE INVENTION

1. Field of the Invention

This invention relates generally fishing rod component design and, more particularly, to a fishing rod guide which receives fishing line through a closeable gap in the guide body.

2. Description of the Prior Art

It is believed that the earliest fishing rods (which were often referred to as angles) can be dated at least back to 2000 B.C. in Egypt. An ancient fishing apparatus may have comprised merely a rod (or pole), line and a hook. It is understood that it was not until the 17^{th} and 18^{th} centuries that fishing rod guides were attached to the rod structure. The typical fishing rod guide (or simply, “guide”) at that time essentially comprised a wire loops attached at various points along the length of the fishing rod. The purpose of the guides is to hold the fishing line close to the rod and transfer the weight from the line to the rod.

Since those early days, although the materials used to build fishing rods and their underlying components have changed substantially, the structure of conventional ring guides has not. Conventional ring guides (in contrast to other guides such as roller guides), whether a of single foot or double foot design, still commonly consist essentially of a wire loop, being a substantially circular ring like structure having an open eye in the middle, attached along the length of a fishing rod. As has been the case since the advent of conventional ring guides, an end of a fishing line is fed through the guide by pulling an end of the fishing line from the base of the rod (typically from a reel) and feeding it (or threading it) sequentially through the eye of a first guide, then a second guide, and eventually through all of the guides along the length of the fishing rod so that a length of line extends from one end of the rod to the other. Significantly, the feeding of a line through the eye of guides in this manner typically requires excellent vision and precise movement. A common problem many individuals encounter when feeding a line through a fishing guide is missing the guide altogether due to poor vision. Therefore, what is needed is an improved design for a fishing rod guide that provides a user who may have less than perfect vision with an easier way to feed a fishing line through a guide. It is understood, however, that such an improved design must still allow the guide to maintain its ability to hold the fishing line securely.

The Applicant's invention described herein provides for a fishing rod guide having a substantially circular body and including a spring clasp mechanism which can be actuated to reveal a closeable gap in the body of the guide. Such a design allows for the fishing line to be fed through the guide in an alternate manner than the typical manner which requires pulling an end of the line through the eye of the guide. The spring clasp guide overcomes the feeding limitation of typical fishing rod guides, and does so in a manner that allows the guide to maintain its ability to hold the fishing line securely. Consequently, any fisherman, including those with limitations in vision and/or dexterity will be able to successfully feed a fishing line.

### SUMMARY OF THE INVENTION

A spring clasp guide for providing an easier method of feeding a fishing line through a fishing guide comprising a substantially circular body and a spring clasp mechanism having a sealing member and an engaging lever. The substantially circular body provides a guide body means for retaining fishing line in a customary manner while the sealing member provides a sealing means for creating a sufficiently contiguous structural body about the circumference of the guide and the engaging lever provides an engaging means for moving the sealing means to create a structural gap in the circumference of the guide.

As such, when the spring clasp mechanism is activated by user actuation of the engaging lever, the sealing member is moved to create a closeable gap in the circumference of the body of the guide. When user actuation is not present, the spring of the spring clasp mechanism functions as a biasing means for positioning the sealing means such that a sufficiently contiguous structural body about the circumference of the guide is maintained. But by revealing a gap in the body of the guide through which fishing line can be received, fishing line could be fed into the guide while arranged parallel to the rod by moving it toward the rod perpendicularly into the guide instead of from an end into the eye of guide. The spring clasp mechanism eliminates the need for a fisherman to feed line through the eyes of a plurality of guides sequentially and spend excessive time on preparing a fishing pole. On the contrary, a fisherman utilizing spring clasp guides on a fishing rod can simply actuate the spring clasp mechanism, insert the line through the closeable gap that is created, and release the spring clasp mechanism to cause the closeable gap to vanish and restore the integrity of the circumference body portion of the guide.

It is an object of this invention is to provide a fishing rod guide through which fishing line can be fed in an alternative means than through the eye.

It is another object of this invention to provide a fishing rod guide which has an opening which can be selectively created by user actuation and through which fishing line can be fed.

It is yet another object of this invention to provide a fishing rod guide which automatically closes such an opening after the removal of user actuation.

It is still another object of this invention to provide a fishing rod guide which automatically maintains the closure of the opening in the absence of user actuation sufficient to retain any inserted fishing line in a manner which is comparable to conventional fishing rod guides.

These and other objects will be apparent to one of skill in the art.

### BRIEF DESCRIPTION OF THE DRAWINGS

FIG. 1 is a partial perspective view of a fishing rod having a spring clasp guide in the closed position, built in accordance with the preferred embodiment of the present invention.

FIG. 2 is a partial perspective view of a fishing rod having a spring clasp guide in the open position and a fishing line ready to be inserted, built in accordance with the preferred embodiment of the present invention.

FIG. 3 is a partial perspective view of a fishing rod having a spring clasp guide in the open position and a fishing line inserted, built in accordance with the preferred embodiment of the present invention.

FIG. 4 is a partial perspective view of a fishing rod having a spring clasp guide in the closed position and a fishing line inserted, built in accordance with the preferred embodiment of the present invention.

### DETAILED DESCRIPTION OF THE INVENTION

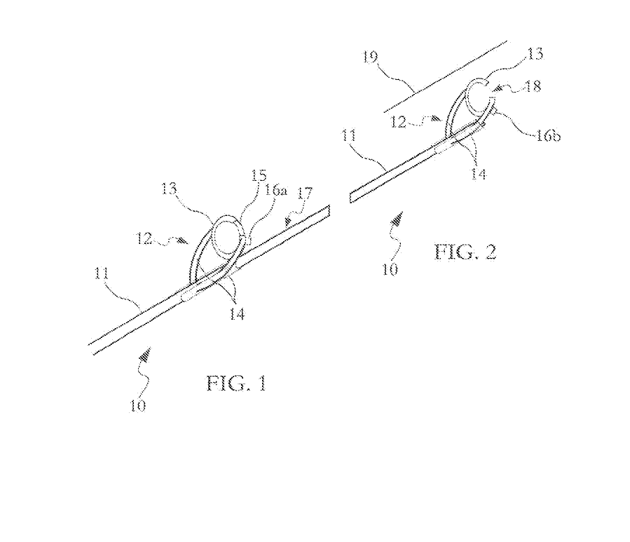

Referring now to the drawings and in particular FIGS. 1 and 2, a partial view of fishing rod assembly 10 built in accordance with the present invention is shown comprising of a customary pole 11 and a spring clasp modified guide 12 attached to said pole 11. It is contemplated that as with typical fishing rod structures, the fishing rod assembly 10 would contain a plurality of guides 12 dispersed along its length. The guide 12 comprises a substantially circular body 13, support attachment members 14, a spring loaded movable sealing member 15, and a spring loaded engaging lever movable to a first position 16a and a second position 16b (general references to the spring loaded engaging lever are denoted by 16). When the sealing member 15 is in position as shown in FIG. 1, the guide's 12 circular body 13 combined with the sealing member 15 form a full structural ring form capable of functioning as a typical fishing rod guide so as to retain any fishing line properly inserted therein.

As with typical spring clasps, the circular body 13 in which the spring clasp is embedded includes a slot sized to slidably fit the engaging lever 16 and a hollow portion at least sized to fit a spring and the sealing member 15. The engaging lever 16a sits in said slot in the circular body 13 and when it is moved in an actuating direction 17, it slides in the slot in the actuating direction 17 around the circular body 13. When this happens, the spring inside the circular body 13 is compressed and the sealing member 15, which is attached to said spring, slides in the actuating direction 17, receding into the hollow portion of the circular body 13.

The engaging lever 16b completes its full range of motion when the sealing member 15 is inside the circular body 13. Thus, the slot in the circular body 13 runs at least from the first position of the engaging lever 16a to the second position of the engaging lever 16b. Because the spring disposed inside the circular body constantly exerts force on the engaging lever 16 and the sealing member 15 in a direction opposing the actuating direction 17, once the pressure which moved the engaging lever 16 in the actuation direction 17 is removed, the engaging lever 16a returns to its first, resting position. At its resting position, the lever 16 sits in the slot in the circular body that is sized to fit the adjacent to the sealing member

When the sealing member recedes into the circular body 13, a receiving gap 18 in the circular body 13 is created. It is in this receiving gap 18 that fishing line 19 which is desired to be fed into the guide 12 can be inserted directly into the guide 12.

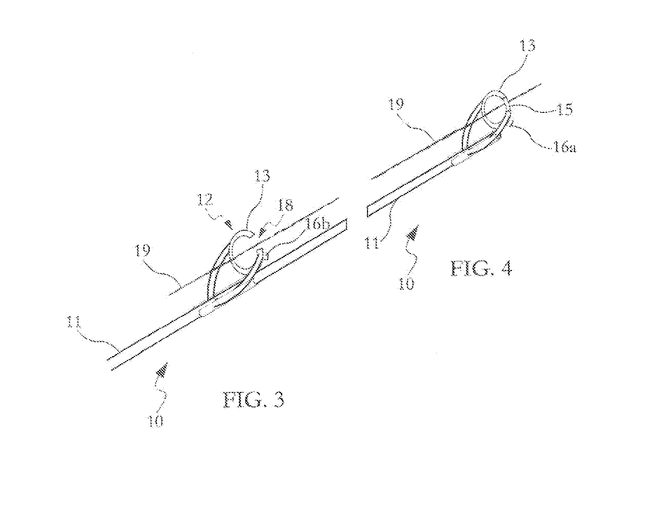

Referring now to FIG. 3, the fishing line 19 is inserted into the circular body 13 of the guide 12 through the receiving gap 18. While, feeding the line 19 in this manner into the guide 12 allows for much quicker insertion and securing of the line 19, it requires the engaging lever 16b to be held in its second position to keep the sealing member 15 inside the circular body 13. Feeding the line 19 in this manner into the guide allows for much quicker insertion and securing of the line 19. To do this, pressure sufficient to resist the spring pressure must be constantly exerted on the engaging lever 16. Once the fishing line 19 is positioned in the inner portion of the circular body 13 of the guide 12, this pressure on the engaging lever 16 can be removed.

Referring now to FIG. 4, once such pressure on the engaging lever 16 is removed, the spring causes the engaging lever 16a to return to its first position and the sealing member 15 to reemerge from the circular body 13. The sealing member 15 and the engaging lever 16a return to their respective resting positions, as shown in FIG. 1. As a result, the guide 12 is returned to its full structural ring form capable of function as a typical fishing rod guide to retain any fishing line 19 inserted therein.

In an alternate embodiment of the present invention, a spring clasp guide is provided in a larger size to suit an end user's particular needs.

In another alternate embodiment of the present invention, a spring clasp guide is provided in a smaller size to suit an end user's particular needs.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A fishing rod guide connected to a fishing rod comprising:
a substantially circular ring shaped body configured to retain fishing line;
a movable sealing member disposed on said ring shaped body, wherein said sealing member is movable to a first position and a second position;
said first position defined by the sealing member being adjacent to the ring shaped body so as to together create a sufficiently contiguous structure about the circumference of the guide; and
said second position defined by at least a part of the sealing member being apart from the ring shaped body so as to create a structural gap in the circumference of the guide.

2. The fishing rod guide of claim 1, additionally comprising an engaging lever which when actuated through the application of pressure in an actuating direction, cause the sealing member to move to said second position.

3. The fishing rod guide of claim 2, wherein the sealing member is maintained in said first position in the absence of pressure on the engaging lever in an actuating direction.

4. The fishing rod guide of claim 3, wherein the sealing member is maintained in said first position by a spring.

5. A fishing rod guide connected to a fishing rod comprising:
a guide body means for retaining fishing line in a customary manner;
a sealing means for creating a sufficiently contiguous structural body about the circumference of the guide; and
an engaging means for moving the sealing means to create a structural gap in the circumference of the guide.

6. The fishing rod guide of claim 5, additionally comprising a biasing means for positioning the sealing means such that a sufficiently contiguous structural body about the circumference of the guide is maintained.

7. A method of threading a fishing line through a fishing rod guide on a fishing rod comprising the steps of:
providing at least one fishing rod guide having a substantially circular ring shaped body, a movable sealing member disposed on said ring shaped body, wherein said sealing member is movable to a first position defined by the sealing member being adjacent to the ring shaped body so as to together create a sufficiently contiguous structure about the circumference of the guide and a second position defined by at least a part of the sealing member being apart from the ring shaped body so as to create a structural gap in the circumference of the guide;
causing the sealing member to move to the second position;
moving fishing line which is oriented in parallel with the fishing rod perpendicular to the fishing rod, towards the guide and through the gap in the circumference of the guide; and
causing the sealing member to move the first position.

8. The method of claim 7, wherein:
the fishing rod guide additionally has an engaging lever which when actuated through the application of pressure in an actuating direction, cause the sealing member to move to said second position; and
the step of causing the sealing member to move to the second position is performed by applying of pressure in an actuating direction on the engaging lever.

9. The method of claim 8, wherein the sealing member is maintained in said first position in the absence of pressure on the engaging lever in an actuating direction.

10. The method of claim 9, wherein the sealing member is maintained in said first position by a spring.
